(19) United States
(12) Patent Application Publication
(10) Pub. No.: US 2013/0032588 A1
(43) Pub. Date: Feb. 7, 2013

(54) HEATING ARRANGEMENT

(71) Applicants: Jan Ihle, Grambach (AT); Werner Kahr, Deutschlandsberg (AT)

(72) Inventors: Jan Ihle, Grambach (AT); Werner Kahr, Deutschlandsberg (AT)

(73) Assignee: EPCOS AG, Munich (DE)

(21) Appl. No.: 13/579,924

(22) PCT Filed: Feb. 14, 2011
(86) PCT No.: PCT/EP2011/052133

§ 371 Date: Oct. 23, 2012

(30) Foreign Application Priority Data
Feb. 19, 2010 (DE) 102010008602.9
May 21, 2010 (DE) 102010021165.6

(51) Int. Cl. H05B 3/02

(52) U.S. Cl. 219/538

(57) ABSTRACT

The invention relates to a heating arrangement in the shape of a frame.

The invention relates to a heating arrangement.

Heating arrangements are used, for example, in industrial or domestic fan heaters or for heating air in cars. The heating arrangements can be provided in outlet openings with various cross-sectional shapes. Heating arrangements for circular, rectangular or square cross sections of outlet openings or ducts through which a medium, for example air, which is intended to be heated can flow are feasible. The heating arrangements have heat-emitting parts which are arranged in the cross-sectional area, so that the medium which is intended to be heated is heated as it flows through the cross-sectional area.

An alternative heating arrangement is the subject matter of patent claim 1: the heating arrangement is in the form of a frame.

The frame-like heating arrangement is formed such that it surrounds a free region which is not intended for heating. The shape of the surrounded free region can be, for example, round, oval or rectangular; however, it is not restricted to these shapes.

In the frame-like heating arrangement, the flowing medium is heated in the cross-sectional area through which it flows. Heating is performed at the edges of the free region by the frame-like heating arrangement.

The heating arrangement is advantageously in the form of a ring, and therefore the surrounded, free region is substantially round or oval. This allows for the heating arrangement to be used in applications in which circular outlet openings are provided. Use in fan heaters is also feasible.

In one refinement, a large number of modules which are arranged around a free region which is framed by the heating arrangement is provided, wherein the modules comprise at least one heating element. The heating element can be heated, for example, by applying a voltage. The heating element can be in the form of, for example, a PTC resistance heating element, that is to say a PTC thermistor. PTC stands for “positive temperature coefficient”. When a voltage is applied, a current flows through the PTC resistance heating element and said PTC resistance heating element heats up, as a result of which the resistance of said PTC resistance heating element increases, this in turn limiting the flow of current. On account of this effect, the PTC resistance heating element can act as a self-regulating heating element.

In one advantageous refinement, the modules comprise emission elements, wherein one or more of the heating elements is arranged between two of the emission elements.

Emission elements are heat-emitting modules which are heated by heat transfer from an adjacent, warm module, such as the heating element, and emit this heat. The emission elements advantageously have a large surface, in particular in comparison to the heating elements, by means of which surface heat is output to the medium which is intended to be heated.

The provision of emission elements and heating elements allows for a modular design of the heating arrangement with optimized modules. The heating elements can be of rather compact design, for example in the form of a plate. The emission elements can be optimized in respect of their emission properties. One exemplary embodiment of an emission element has ribs. The ribs can face the free region or, in an alternative refinement, be averted from said free region. Another exemplary embodiment is folded in a meandering manner; this can be achieved by folding a metal sheet. In these exemplary embodiments, the surface is much larger than a compact body such as a cuboid. The air flowing past comes into contact with a large surface at which said air is heated. In an alternative exemplary embodiment of the emission element, apertures are provided instead of ribs, it being possible for the air to flow through said apertures. A body which is suitable for emitting heat can be produced, for example, from a perforated metal sheet.

The heating element can be electrically conductively connected to the emission elements. At least one of the heating elements is electrically conductively connected to the adjacent emission elements. An electrically conductive connection of this kind is already achieved when the heating element touches the adjacent emission element which is formed from electrically conductive material. This makes it possible both for the heating element to be supplied with voltage via the adjacent emission elements and also for a plurality of heating elements, between which emission elements are provided, to be connected physically in series and electrically in parallel.

At least one contact frame, which makes electrical contact with at least one of the modules, is advantageously provided. A supply potential is applied via the contact frame to the module with which electrical contact is made. Contact can be made by virtue of the contact frame touching the module with which contact is intended to be made. A further contact frame is advantageously provided in order to apply a further supply potential. The applied supply voltage is given by the potential difference.

In one embodiment, the contact frame runs on the faces of the modules which face the free region. As an alternative, the contact frame runs on the faces of the modules which are averted from the free region. The contact frame can have a supporting function for the modules, for example when a first contact frame runs on that face which is averted from the free region and a second contact frame runs on that face which faces the free region. As an alternative, both contact frames can run along that face which faces the free region or along that face which is averted from the free region; the latter case would not influence the emission of heat into the free region.

The contact frame advantageously has an insulation means in regions which are adjacent to modules with which contact is not intended to be made. In other words: no insulation means is provided in the region of the module with which contact is intended to be made. The insulation means prevents contact being made unintentionally.

In one advantageous embodiment, the modules are clamped to one another along at least one section of the frame profile, and therefore they are held in their position in a non-positive manner. As a result of the clamping, adjacent modules touch one another, and therefore both good heat transfer from the heating elements to the emission elements and an electrical connection between the modules are achieved. Spring elements can be provided in order to improve the press-fit, said spring elements being clamped in a non-positive manner between two other modules, preferably between two emission elements. The emission elements and the spring elements are advantageously electrically conductive. In one exemplary embodiment, the spring elements are produced from pre-bent spring steel which, when it is positioned between two modules, transmits a compressive stress to said modules.

A frame-like housing in which the modules are arranged is provided in one refinement. The modules which are clamped to one another are advantageously pressed against at least one wall of the housing in order to hold them in their position. In the case of a round housing, the modules are pressed, for example, against the outer face of the housing.

The frame-like housing advantageously has an inner face which faces the free region, and an outer face which is averted from said free region, and also front and rear faces which are perpendicular to the inner face. At least one of the faces has cutouts through which the medium which is intended to be heated can come into contact with the modules. In one refinement, the inner face of the housing is closed, and therefore the the heat is emitted at least via one of the other faces, for example the outer face. In another embodiment, the inner face and outer face are closed, and therefore medium can flow axially through the housing via the front face and rear face.

The invention will be explained below using exemplary embodiments with reference to the drawing, in which:

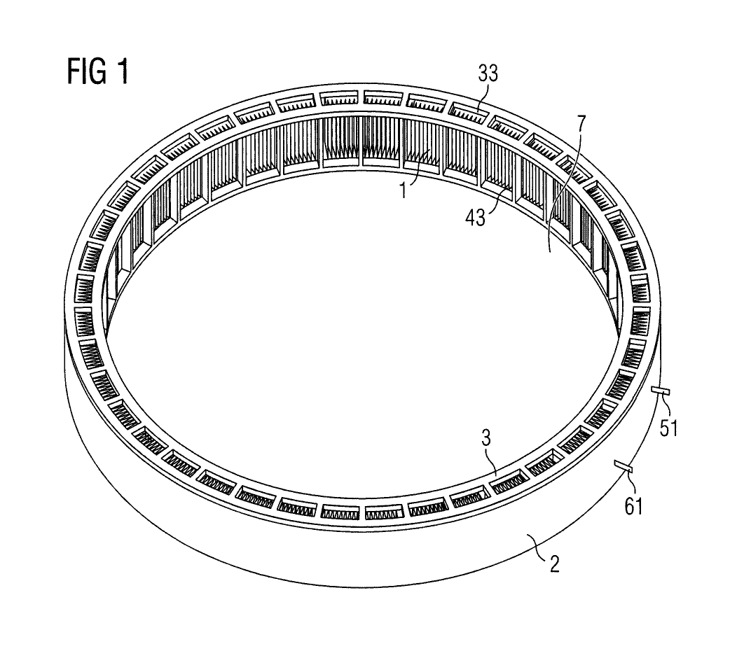

FIG. 1 shows an exemplary embodiment of a ring-like heating arrangement,

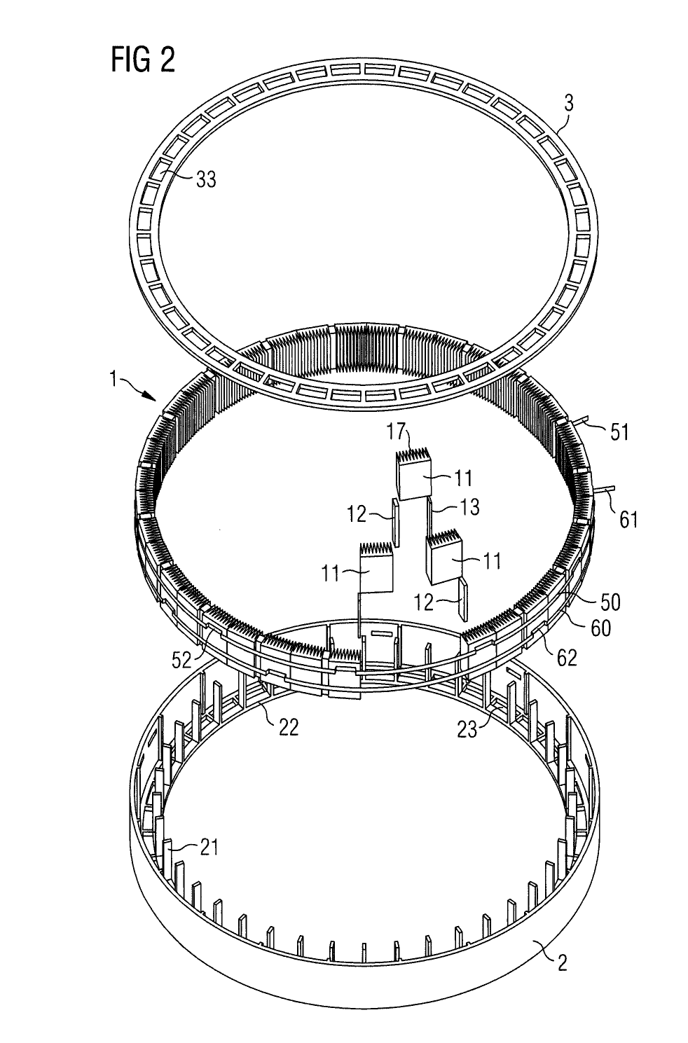

FIG. 2 shows an exploded drawing of the ring-like heating arrangement,

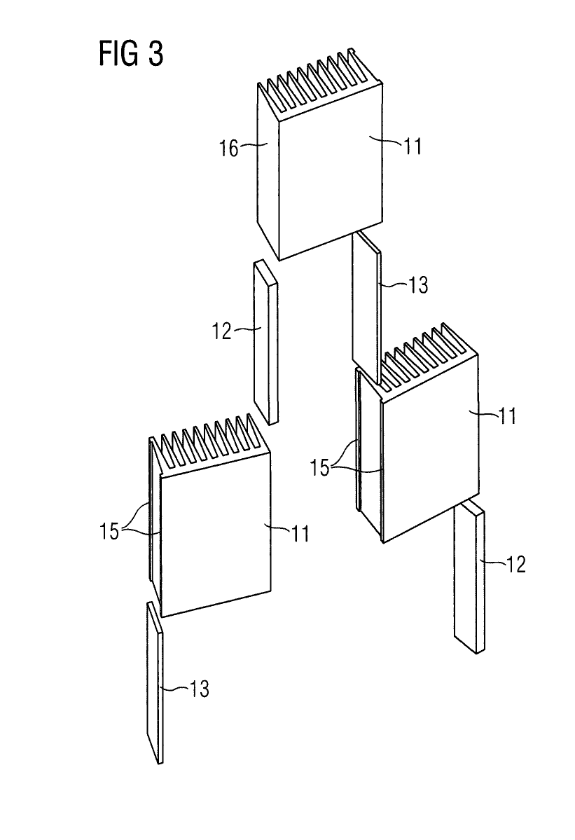

FIG. 3 shows modules of the heating arrangement,

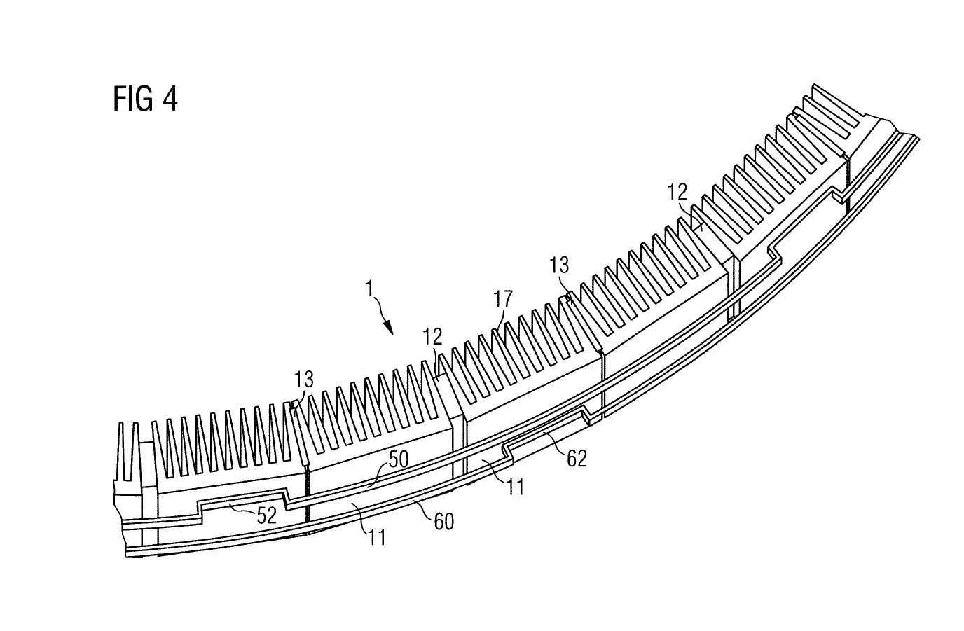

FIG. 4 shows a detail of a ring heater of the heating arrangement, and

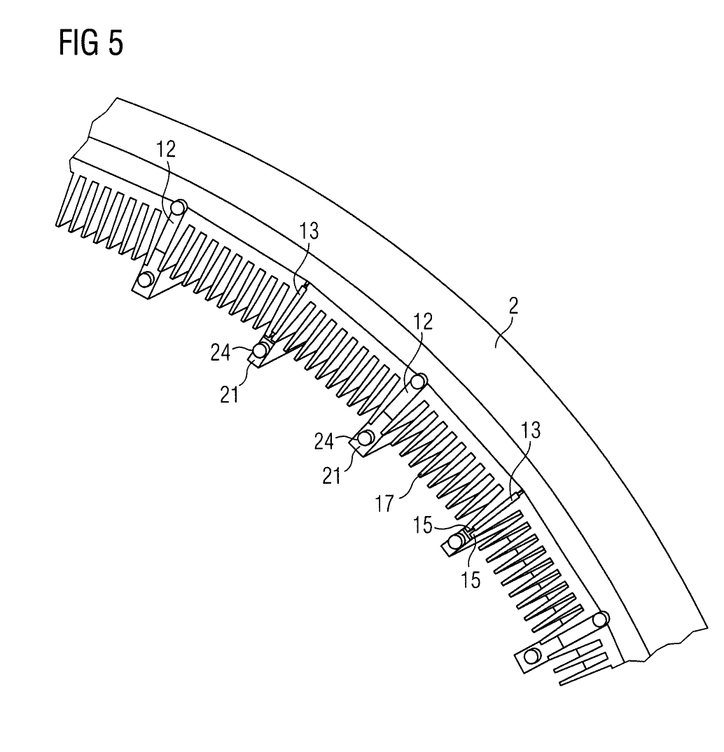

FIG. 5 shows a detail of the ring heater in a housing shell.

FIG. 1 shows an exemplary embodiment of a heating arrangement in the form of a ring with self-regulation. The heating arrangement comprises a ring heater 1 which is arranged in the form of a ring in a housing 2, 3. The free region 7 which is enclosed by the ring is not available for positioning heating means.

The ring heater 1 emits heat which can heat the medium, for example air, in the cross section in which the emission elements 11 are arranged and through which said medium flows. The ring heater 1 is arranged in a ring-like, concentric housing comprising a housing shell 2 and a housing cover 3. The ring heater 1 and the housing 2, 3 run around the free region 7 which does not contain parts of the heating arrangement.

The housing 2, 3 has an inner face which faces the free region, an outer face which is averted from said free region, and also a front face and a rear face which are substantially perpendicular to the inner face and the outer face. The inner face, outer face and rear face are part of the housing shell 2. The housing cover 3 serves as the front face. Cutouts 33, 43 are provided in the inner face and in the front face and rear face, it being possible for heat to be emitted through said cutouts without obstruction. The housing 2, 3 can be produced from plastic.

FIG. 2 shows an exploded drawing of the heating arrangement which is illustrated in FIG. 1.

The ring heater 1 comprises a plurality of modules 11, 12, 13. The modules comprise heating elements 12 which heat up when a voltage is applied. The heating elements 12 provided can be PTC resistance heating elements which are in the form of cuboidal ceramic plates in this exemplary embodiment. A possible material is, for example, barium titanate ceramic.

Emission bodies 11 are also provided, said emission bodies being suitable for dissipating and emitting heat from the heating elements 12. The emission bodies 11 comprise ribs 17 via which heat is emitted in the direction in which medium flows through. In this exemplary embodiment, the emission elements 11 are formed from metal, for example aluminum.

In the event of deformation, spring elements 13 exert a force which counteracts the deformation. In one exemplary embodiment, the spring elements 13 are formed as pre-bent spring steel plates.

The ring heater 1 comprises a plurality of emission elements 11, heating elements 12 and spring elements 13 which are arranged next to one another in the form of a ring.

The emission elements 11 are arranged around the free region 7 such that they are distributed over the entire ring. Heating elements 12 and spring elements 13 are arranged between the emission elements 11. In each case one heating element 12 is located between two emission elements 11. Spring elements 13, which are likewise arranged such that they are distributed over the circumference of the circle, are located between the emission elements 11 in order to establish electrical and thermal contact by means of a press-fit. Either a heating element 12 or a spring element 13 is advantageously arranged between two of the emission elements 11. Heating elements 12 and spring elements 13 alternate with one another.

A first, substantially ring-like contact frame 50 and a second, substantially ring-like contact frame 60 are arranged around the modules 11, 12, 13 which are arranged in the form of a ring. A voltage can be applied to the contact frames 50, 60 by means of contact lugs 51, 61 which are oriented radially to the outside. The contact lugs 51, 61 are routed to the outside through the housing shell 2. The contact frames 50, 60 have contact regions 52, 62 by means of which the modules are in each case alternately electrically connected to the contact frames 50, 60 in order to allow for parallel connection.

The ring heater 1 is positioned in the housing shell 2. The housing shell 2 has a base 22, which is the rear face of the housing, and also an inner face and an outer face. The inner face of the housing is structured in such a way that the modules 11, 12, 13 can be positioned therein. Compartments which can accommodate the modules 11, 12, 13 are formed by webs 21 on the inner face of the housing shell 2.

The modules 11, 12, 13 are fitted into the housing shell 2 and clamped to one another in a ring-like manner in such a way that this press-fit results in the adjacent modules 11, 12, 13 touching and there being a thermal series connection along the circuit. The result is a thermal series connection of the emission elements 11 with the heating elements 12 which are situated between said emission elements and act as heat sources. The housing shell 2 prevents the radial movement of the modules 11, 12, 13 which are clamped to one another.

The housing cover 3 is mounted on the housing shell 2 after the modules 11, 12 have been positioned in the housing shell 2. The housing cover 3 prevents the modules 10, 11, 12 from slipping out and, like the rear face 22 on the housing shell 2 and the inner face of said housing shell, is provided with cutouts 23, 33, 43. The medium which is intended to be heated can flow directly through the ribs 17 of the emission elements 11 through the cutouts 23, 33, 43. This improves the output of heat.

FIG. 3 shows the modules 11, 12, 13 in detail. The emission elements 11 are cuboidal aluminum blocks with trenches on a face which, in this exemplary embodiment, faces the free region 7. The ribs 17 which are formed as a result of this are used to emit heat from the adjacent heating module 12. One face of the emission element 11 has two webs 15. The opposite face 16 is flat. During assembly, adjacent emission elements 11 are positioned such that the faces with the webs 15 face one another and form a cutout in which the spring element 13 can be positioned. The webs 11 assist assembly and prevent the spring element 13 from slipping out. The flat faces 16 of adjacent emission elements 11 face the heating element 12 in order to allow contact with good heat transfer over as large an area as possible.

FIG. 4 shows a detail of the ring heater 1 of the heating arrangement. The above-described arrangement of the modules 11, 12, 13 can be clearly seen: the repeated sequence of an emission element 11, a heating element 12, an emission element 11 and a spring element 13.

The modules 11, 12, 13 are electrically conductively connected to one another, this being achieved by the contact between the modules 11, 12, 13 which is created by the press-fit. The supply voltage is fed by means of the first contact frame 50 and the second contact frame 60. In this exemplary embodiment, the contact frames 50, 60, which are in the form of ring strips, run on that face of the modules 11, 12, 13 which is averted from the inner face of the ring.

There is electrical contact only between some of the emission elements 11 and the contact frames 50, 60. Contact is made by alternating contact between the contact frames 50, 60 and the emission elements 11. In this exemplary embodiment, contact is made with each fourth emission element 11, with the emission elements 11 with which contact is made by the first contact frame 50 being offset by two emission elements 11 in relation to the emission elements 11 with which contact is made by the second contact frame 60.

In this exemplary embodiment, the contact frames 50, 60 are not situated on the outer faces of all the emission elements 11, but rather touch only the emission elements 11 with which contact is intended to be made. This can be achieved by the diameter of the contact frames 50, 60 being greater than the diameter of the modules 11, 12, 13 which are arranged in a circle; the contact frames 50, 60 have radially inwardly curved contact regions 52, 62, by means of which electrical contact is made with the emission elements 11, only in the regions of the modules with which contact is intended to be made. This implementation can be stepped, pointed or round or have another shape. In an alternative exemplary embodiment (not illustrated), radially inwardly directed projections are provided for the purpose of making contact. The contact regions 52, 62 are formed such that a spring action achieves an adequate electrical contact-connection when emission elements 11 are installed.

The contact frames 50, 60, with the exclusion of the inwardly curved contact regions 52, 62, are advantageously provided with an electrical insulation means which surrounds the contact frames 50, 60 or is fitted only on the inner face of said contact frames. The insulation means can be composed of plastic. The contact frames 50, 60 are routed in the housing shell 2 or are firmly anchored in said housing shell. In one exemplary embodiment, the contact frames 50, 60, with the exclusion of the contact regions 52, 62, are encapsulated or injection-molded in the housing shell 2.

The heating arrangement is self-regulating on account of the use of PTC resistance heating elements. The parallel connection between the PTC resistance heating elements, which parallel connection is necessary for the electrical design, is established by means of the contact frames 50, 60. The emission elements 11 with which contact is made by the first contact frame 50 are connected to the same potential. The emission elements 11 with which contact is made by the second contact frame 60 are connected to a different potential which is the same for said emission elements. This produces a parallel connection of sections of the ring heater 1. The sections run between the emission elements 11 with which contact is made by the first and second contact frames 50, 60. The parallel connection of sections allows the supply voltage which is required for heating to be supplied to the heating elements 12.

FIG. 5 shows a detail of the ring heater 1 which is arranged in the housing shell 2.

The web-like structures 21 on the inner face of the housing shell 2 allow for secure positioning of the modules 11, 12, 13. Accommodation regions are provided for the emission elements 11 and for the heating elements 12. The spring elements 13 are positioned in the cutouts between two adjacent emission elements 11. A force acts on the adjacent modules on account of their spring action. A press-fit is produced on account of the plurality of spring elements 13 which are distributed over the ring heater 1. When the ring heater 1 is installed in the housing shell 2, a press-fit is achieved by virtue of the spring elements 13 between the emission elements 11 and the heating elements 12, the adjacent modules 11, 12, 13 being clamped to one another in the case of said press-fit, and therefore the modules 11, 12, 13 touch and a thermal and electrical connection is established. The housing shell 2 prevents the modules 11, 12, 13 which are clamped to one another from radially moving away from one another.

Fastening devices are also provided, it being possible the fix the housing cover 3, which closes the housing shell 2, to the housing shell 2 by means of said fastening devices. This can be achieved, for example, by raised portions which are positioned in a non-positive and/or positive manner in holes in the housing cover 3. Snap-action connections are also feasible.

It should be noted that the features of the described exemplary embodiments can be combined.

### REFERENCE SYMBOLS

1 Ring heater
2 Housing shell
3 Housing cover
7 Free region
11 Emission element
12 Heating element
13 Spring element
15 Web
16 Flat face
17 Rib
50, 60 Contact frame
51, 61 Contact lug
52, 62 Contact region
21 Web
22 Rear face of the housing
23, 33, 43 Cutout
24 Raised portion

1. A heating arrangement in the form of a frame.

2. The heating arrangement according to claim 1 in the form of a ring.

3. The heating arrangement according to claims 1 or 2, comprising a plurality number of modules which are arranged around a free region which is framed by the heating arrangement, wherein the modules comprise at least one heating element.

4. The heating arrangement according to claim 3, wherein the plurality of modules comprise emission elements, and wherein one or more of the heating elements is arranged between two of the emission elements.

5. The heating arrangement according to claim 4, wherein at least one of the heating elements is electrically conductively connected to the adjacent emission elements.

6. The heating arrangement according to claim 3, having at least one contact frame which makes electrical contact with at least one of the modules.

7. The heating arrangement according to claim 6, wherein the contact frame runs on the faces of the modules which face the free region, or runs on the faces of the modules which are averted from the free region.

8. The heating arrangement according to claim 6, wherein the contact frame comprises an insulation means in regions which are adjacent to modules with which contact is not intended to be made.

9. The heating arrangement according to claim 3, wherein the modules are clamped to one another along at least one section of the frame profile.

10. The heating arrangement according to claim 3, wherein the plurality of modules comprises spring elements which are clamped between two modules.

11. The heating arrangement according to claim 1, further comprising a frame-like housing.

12. The heating arrangement according to claim 11, wherein the housing has an inner face which faces the free region, and an outer face which is averted from said free region, and also front and rear faces, wherein at least one of the faces has cutouts.

13. The heating arrangement according to claim 4, wherein the emission elements comprise ribs or are folded in a meandering manner or are in the form of bodies with apertures.
